(19) United States
(12) Patent Application Publication
(10) Pub. No.: US 2024/0135403 A1
(43) Pub. Date: Apr. 25, 2024

(54) Recognition-based reward automatic cash redemption methods and systems to process qualifying food purchases

(71) Applicant: Sin Ping Fok, Hung Hom (HK)

(72) Inventor: Sin Ping Fok, Hong Kong (HK)

(21) Appl. No.: 17/970,541

(22) Filed: Oct. 19, 2022

(51) Int. Cl. G06Q 30/02; G06Q 50/12

(52) U.S. Cl. CPC G06Q 30/0215; G06Q 50/12

(57) ABSTRACT

A system and method for uploading a picture of a receipt to receive automatic cash redemption for qualifying food purchases made during a dining experience at an affiliate restaurant. Social recognitions are earned from using open source GUI for the uploads. The system assigns qualifying food purchases to destination accounts associated with the dining experience, receives dietary rules to be applied to a dining experience, offers recognition-based awards to destination accounts associated with the dining experience. As food purchases are made, each of the purchases is processed by the system by evaluating the purchase against the dietary rules. Based on the evaluation, qualifying food purchases are assigned to a destination account. Destination accounts, including a listing of assigned food purchases, may then be displayed to users of the system, such as restaurant guests and restaurant staff.

### FIELD OF THE INVENTION

This invention relates to shopping incentives based on sustainable dining experience, and in particular to the generation of incentives based on locally sourced ingredients.

### BACKGROUND

A cultural and technological framework is very much needed for young women to plug into quickly, know where they stand, and start applying themselves with a clear sense that they're making an impact and have a path to success in front of them.

A growing body of research is showing the industry that gender diversity makes business sense. Computing jobs are among the fastest-growing in today's economy. It is estimated by 2020 there will be 1.4 million jobs in computer science, but only 8% of those jobs will be held by women. Businesses need to stay ahead of the technology curve if they are to recruit and retain millennial talent who have grown up living and breathing in a fully connected environment.

Women-led companies have been found to perform better than those led by men. And gender diverse research and development teams are known to increase innovation. Programs around the world are taking a stand to promote women to study and find careers in computer science and technology. Femtech would reach $50 billion value in the next 5 years. Recent wins by leading companies and the awareness generated by the female entrepreneur community has helped the space get on the radar of prominent investors.

Technology isn't a perk, it's an enabler of a smarter working era, where both employees and organisations can capitalise on the freedom, personalisation and flexibility that digital tools can offer. Technology is such an essential part of our world that having just a basic knowledge of some programming languages or something similar can benefit those in any field, not just technology.

Millennials are open minded and curious, always looking for more than just a meal. They have an insatiable appetite for clarity. Clarity of performance feedback, clarity on career progression and—perhaps above all—clarity in terms of purpose. There is less patience than ever for ‘just doing work’.” They value adventure and consider food another way to experience the world with friends. Millennials are also more likely to see communal seating as an opportunity to experience new social connections. Experts agree the shift toward plant-based consumption is primarily driven by millennials, a group most likely to consider the food source, environmental impact and animal welfare issues when making a purchase. While millennials currently boast the largest percentage of self-identified vegans and vegetarians, Gen Z is on their heels and may be even more into vegan food. Investigative millennials, in particular, find overwhelming value in the access to information regarding the sources and ingredients of any product they might purchase. At 81 million members strong, millennials are connected, curious, and capable of driving consumer trends into the future. They understand technology and know where to get the answers they are looking for. With more spending power than any other generation, manufacturers, merchandisers and marketers should take note of millennials' need for brand information and interaction.

The increased value millennials place on technology is more about the underpinning social and cultural drivers as opposed to the innate desire to use technology more heavily. 78% of millennials prefer spending money on an experience or an event to buying something desirable. Three out of four millennials say sharing food among friends, family or coworkers is a great way to socialise. 77% of millennials say restaurant technology improves their dining experience. 73% of global millennials are willing to pay more for sustainable goods. 18-35 year olds spend five days a year browsing food images on Instagram, and 30% would avoid a restaurant if their Instagram presence was weak.

Young people are taking control of their own pathway to careers, college and contribution. Powered by digital learning, “GenDIY” is combating unemployment and the rising costs of earning a degree by seeking alternative pathways to find or create jobs they love. Research supports that a key factor in maintaining girls' interest in computer science is providing female role models who can combat the perception of computer science as a career option only for men.

It is therefore imperative to have a technology framework that incentivizes collaborative work, participation in design or making activity, and making an impact in the GenDIY vegan community.

### SUMMARY

A sustainable dining experience management system that's designed specifically for social recognition is disclosed herein. The sustainable dining system interacts with users through its GUI to provide food purchases and coder information, determines redeemable restaurant menu items, and distributes rewards across users. Cash rewards are offered to incentivize socially driven consumer users to become open source coders of their own GUIs. To accomplish this task, a user may be assigned to multiple roles by using and programming open-source GUI, and be rewarded as such. Offers are redeemed when a receipt is scanned using a user choice of GUI authored by an in-network coder. A restaurant uses mix rewards to encourage a user to buy more volume of higher mix, or margin, items, or sell more to selected consumers or consumer segments. In certain embodiments, funding sources for rewards include women-led technology companies, government grants, and venture capital funds.

The sustainable dining experience management system 200 leverages Github as an online collaborative platform for managing coders and their rewards. Open workflow and transparency features in conjunction with distributed version control offers coders the ability to reuse and remix programming materials (through distributed version control), while offering fellow coders in the community a chance to also contribute to programming materials (e.g., through pull requests). Diffs, issue tracking, and merge requests in GitHub provide support for code reviews, a peer-review process that promotes a positive attitude towards work, as well as training in critical reviewing and communication skills. Any work that coders want to be made public can be moved to their own public Git presence and can then be shared, e.g., with community users and other fellow coders in the community. Participation is incentivized because coders are rewarded for forking. Forking is the task of creating a new software project from existing artifacts of another software project. Artifacts are not limited to source code. They can be anything related to the software that a project aims to develop, such as documentation, examples, test harnesses and third party libraries. The forked project (or simply the fork) can be used for enhancement, bug fixes, innovation and so on. A fork and the one from which it is forked forms a successor-predecessor relationship. A successor coder has a vested interest in the original GUI project from which it was forked but the coder of the original GUI project may not necessarily be aware of the forks created and their development activities. The system 200 may offer a reward to the original coder when a user uses the predecessor GUI project to scan receipts. Further, sustainable dining experience management 200 may offer a reward to a successor coder when a user uses a fork project to scan receipts. In one embodiment, rewards may be offered to both the successor coder and the predecessor coder of a fork. Sustainable dining experience management 200 may limit the number of rewards coders may earn per user, per restaurant throughout an offer period.

Role models are key in gender diversity, and female role models in tech attract more diverse talent. The sustainable dining experience management system 200 incentivizes coders to grant more rights and impose fewer restrictions for forking. In one embodiment of the invention, when a user scans receipts using a predecessor GUI project, the predecessor coder may be offered a reward proportional to the number of rights granted and restrictions imposed on the predecessor project by the coder. Some typical rights and restrictions thereof include right to perform, right to display, right to copy, right to modify, right to distribute, and right to sublicense. As a general rule of thumb, the more granted rights and fewer imposed restrictions the higher social recognition an original GUI coder earns. Higher social recognition earns higher classes of rewards for the coder.

Forking is regarded as a source of innovation, and Sustainable dining system 200 incentivizes coders to make more frequent forkings. In one embodiment of the invention, the system 200 may assign a higher social recognition to a coder if the system 200 determines that the coder forks frequently within a predefined period of time. As such, the system 200 may assign the coder higher classes of rewards, which in turn may earn the coder upgrades when the fork GUI projects are used to scan receipts.

Crowd-sourced expertise is celebrated and social recognition is encouraged. Sustainable dining experience system 200 incentivizes users to support innovation by using a variety of successor forks. In certain embodiments, the system 200 may assign a higher social recognition to a user if the system 200 determines that the user uses a number of fork GUI projects frequently within a predefined period of time. As such, the system 200 may assign the user higher classes of rewards, which in turn may earn the user upgrades subsequently.

For a given user in the network, a recognition-based reward management module 206 classifies the social recognition factors associated with the user. In this example, the above fork factors are open source advocacy, role modeling, and forking. As noted, the social recognition factors that recognition-based reward management module 206 makes available for selection are controlled and consistent.

The system 200 may handle a variety of dining-out scenarios: When one person orders redeemable dishes or multiple people have ordered redeemable dishes, it may split redeemable offers evenly based on the dishes or allow you to select individual dishes for each person to redeem. The share function allows you to send a dining-out experience via email, social media, or any other channel. Dining-out experiences are backed up and synced for all people in the group so each person can see them.

When a user goes dining, the GUI assists the user in selecting redeemable dishes at a restaurant. After a user has completed dining, the user keeps the receipt, clicks the Upload Receipt button and follows the instructions to redeem the offer by scanning the receipt, and to select a list of offers available at the restaurant. Some vegan or vegetarian restaurants are affiliated, where all menu items are redeemable. Some flexitarian restaurants may also offer redeemable dishes on their menu. For people who frequently dine out together and generally eat at affiliated restaurants, sharing a bill among friends is encouraged. Instead of uploading separate checks, uploading a single check with one or more redeemable dishes makes all dishes on the same receipt redeemable.

### DETAILED DESCRIPTION

A sustainable dining experience management system that's designed specifically for social recognition is disclosed herein. Source of information and tip-sharing is provided for its users, who swap recipes, ideas for meat substitution, and advice on the best places to buy food, and also organize meat-free social events. It is an object of certain embodiments of the present invention to promote compassion by raising awareness of what meat is and the cruelty involved, providing tools for a network of users and freelancers to produce sponsored editorial for local sustainable restaurants and farms. The sustainable dining system interacts with users through its GUI to provide food purchases and coder information, determines redeemable restaurant menu items, and distributes rewards across users. Cash rewards are offered to incentivize socially driven consumer users to become open source coders of their own GUIs. To accomplish this task, a user may be assigned to multiple roles by using and programming open-source GUI, and be rewarded as such. Offers are redeemed when a receipt is scanned using a user choice of GUI authored by an in-network coder. A restaurant uses mix rewards to encourage a user to buy more volume of higher mix, or margin, items, or sell more to selected consumers or consumer segments. In certain embodiments, funding sources for rewards include women-led technology companies, government grants, and venture capital funds.

Referring to the example of FIG. 1, a representative environment 100 in which aspects of the described technology may operate includes one or more customer computing devices 105, staff computing devices 110, and server computers 115 and 120, wherein the server computers comprise a data repository 130 comprising a plurality of user entries and a plurality of class-of-rewards definitions associated with a plurality of classes-of-rewards, wherein each of the plurality of user entries is associated with a plurality of classes-of-rewards and wherein each of the plurality of class-of-rewards definitions comprises an InterestedRestaurant attribute listing at least one associated restaurant, a directory server configured to execute a first operation to obtain initial results and apply a social recognition filter to obtain final results, wherein the social recognition filter uses the initial results and the InterestedRestaurant attribute of the at least one of the plurality of classes-of-rewards to obtain the final results, and a GUI application configured to request the directory server to execute the first operation and the control. Typically, each class-of-rewards is pre-assigned to a reward zone, and a reward zone is typically pre-selected by a participating restaurant. After receiving information about purchases, the server computers 115 apply corresponding purchases associated with each purchase to the correct account based on the maintained account dietary rules. Users view information regarding qualifying food purchases in each of the accounts through a user interface on customer computing device 105 and 110.

When a user goes dining, the GUI assists the user in selecting redeemable dishes at a restaurant. After a user has completed dining, the user keeps the receipt, clicks the Upload Receipt button and follows the instructions to redeem the offer by scanning the receipt, and to select a list of offers available at the restaurant. Some vegan or vegetarian restaurants are affiliated, where all menu items are redeemable. Some flexitarian restaurants also offer redeemable dishes on their menu. For people who frequently dine out together and generally eat at affiliated restaurants, sharing a bill among friends is encouraged. Instead of uploading separate checks, uploading a single check with one or more redeemable dishes makes all dishes on the same receipt redeemable.

A user can create groups with various friends and divide up what each person eats. The GUI gives everyone in the group a “plate.” Then as items are added to the group, they can be placed on a specific person's plate or split up among the entire group. All a user's shared dining experiences and rewards are organized in one place and everyone in the group can see the amount. A user can link a user account to a debit or credit card of your choice. They can leave the money in the account for future social use—like a “fun money” account separate from their regular checking—or, if they need the money, can “cash it out” by transferring to their bank account of choice.

FIG. 2 is a block diagram illustrating a sustainable dining experience system 200 comprises several modules for processing. A user interface module 202 generates graphical user interfaces (GUIs) to allow users to access the system 200. For example, the user interface module 202 generates a GUI for viewing which redemption methods are associated with each account, allowing a user to add additional redemption methods to an account or remove existing redemption methods. The user interface module 202 also generates a GUI for presenting different criteria (e.g., nutritional values, purchase type, source of purchase, date of purchase, amount of purchase, etc.) that are utilized by a user creating a rule. In certain embodiments, the user interface module 202 generates different GUIs for different users. For example, a listing of purchases generated for a guest does not display the amounts of certain purchases (for example, when the associated account is configured to hide purchases from the guest) while the listing of purchases generated for the staff list all purchase amounts. The user interface module 202 also provides application programming interfaces (APIs) to enable communication and interfacing with the system 200. APIs to be used by other applications, web portals, or distributed system components to use the system.

The sustainable dining experience management system 200 leverages Github as an online collaborative platform for managing coders and their rewards. Open workflow and transparency features in conjunction with distributed version control offers coders the ability to reuse and remix programming materials (through distributed version control), while offering fellow coders in the community a chance to also contribute to programming materials (e.g., through pull requests). Diffs, issue tracking, and merge requests in GitHub provide support for code reviews, a peer-review process that promotes a positive attitude towards work, as well as training in critical reviewing and communication skills. Any work that coders want to be made public can be moved to their own public Git presence and can then be shared, e.g., with community users and other fellow coders in the community. Participation is incentivized because coders are rewarded for forking. Forking is the task of creating a new software project from existing artifacts of another software project. Artifacts are not limited to source code. They can be anything related to the software that a project aims to develop, such as documentation, examples, test harnesses and third party libraries. The forked project (or simply the fork) can be used for enhancement, bug fixes, innovation and so on. A fork and the one from which it is forked forms a successor-predecessor relationship. A successor coder has a vested interest in the original GUI project from which it was forked but the coder of the original GUI project may not necessarily be aware of the forks created and their development activities. The system 200 may offer a reward to the original coder when a user uses the predecessor GUI project to scan receipts. Further, sustainable dining experience management 200 may offer a reward to a successor coder when a user uses a fork project to scan receipts. In one embodiment, rewards may be offered to both the successor coder and the predecessor coder of a fork. Sustainable dining experience management 200 may limit the number of rewards coders may earn per user, per restaurant throughout an offer period.

In one embodiment of the invention, the system 200 limits the number of rewards a user may earn per project, per restaurant in a predefined offer period. When a user scans receipts using a predecessor GUI project from a first original coder at a restaurant, the system 200 may not offer any rewards to the user if the system 200 determines that a first predecessor-user-restaurant limit is reached. Further, when the user scans receipts using a successor GUI project from a second fork coder at the restaurant, the system 200 may offer rewards to the user if the system 200 determines that a second successor-user-restaurant limit has not been reached.

Role models are key in gender diversity, and female role models in tech attract more diverse talent. The sustainable dining experience management system 200 incentivizes coders to grant more rights and impose fewer restrictions for forking. In one embodiment of the invention, when a user scans receipts using a predecessor GUI project, the predecessor coder may be offered a reward proportional to the number of rights granted and restrictions imposed on the predecessor project by the coder. Some typical rights and restrictions thereof include right to perform, right to display, right to copy, right to modify, right to distribute, and right to sublicense. As a general rule of thumb, the more granted rights and fewer imposed restrictions the higher social recognition an original GUI coder earns. Higher social recognition earns higher classes-of-rewards for the coder.

Forking is regarded as a source of innovation, and Sustainable dining system 200 incentivizes coders to make more frequent forkings. In one embodiment of the invention, the system 200 may assign a higher social recognition to a coder if the system 200 determines that the coder forks frequently within a predefined period of time. As such, the system 200 may assign the coder higher classes-of-rewards, which in turn may earn the coder upgrades when the fork GUI projects are used to scan receipts.

Crowd-sourced expertise is celebrated and social recognition is encouraged. Sustainable dining experience system 200 incentivizes users to support innovation by using a variety of successor forks. In certain embodiments, the system 200 may assign a higher social recognition to a user if the system 200 determines that the user uses a number of fork GUI projects frequently within a predefined period of time. As such, the system 200 may assign the user higher classes-of-rewards, which in turn may earn the user upgrades subsequently.

For a given user in the network, a recognition-based reward management module 206 classifies the social recognition factors associated with the user. In this example, the above fork factors are open source advocacy, role modeling, and forking. As noted, the social recognition factors that recognition-based reward management module 206 makes available for selection are controlled and consistent. The selection criteria includes the user, as well as the predecessor coder and the successor coder identified in a successor-predecessor relationship of the open source GUI project of user choice.

Each social recognition factor that is available for selection has a corresponding social recognition value. For example, the Open Source Advocacy factors could be computed as follows:
Open Source Advocacy #1—Try New GUI Every Six Months: fork value=2.
Open Source Advocacy #2—Try New GUI Every Three Months: fork value=4.
Open Source Advocacy #3—Try New GUI Every One Month: fork value=6.

For another example, the Role Modeling factors could be computed as follows:
Role Modeling #1—Owner of GUI project with four or more imposed restrictions: fork value=2.
Role Modeling #2—Owner of GUI project with two or more imposed restrictions: fork value=4.
Role Modeling #3—Owner of GUI project with no imposed restrictions: fork value=6.

For another example, the Forking factors could be computed as follows:
Forking #1—Owner of one or more fork GUI projects: fork value=2.
Forking #2—Owner of five or more fork GUI projects: fork value=4.
Forking #3—Owner of ten or more fork GUI projects: fork value=6.

For a given user, the social recognition values for all of its social recognition factors are added together to get a total value for the user. Prior to summing to the total value, the individual social recognition values may be normalized.

For the social recognition reward, a set of key variables is assessed to determine compatibility between the user and the various classes-of-rewards. In this example the classes-of-rewards are: Silver, Gold, Platinum, and Titanium, although different classes-of-rewards could be used. The key variables are:
Open Source User Reward—what is the amount of rewards a user is allowed to earn per qualifying food purchase at a restaurant.
Open Source User Limit—what is the maximum amount of rewards a user is allowed to earn during a given time period.
Original Coder Reward—what is the amount of rewards an original GUI coder is allowed to earn per qualifying user purchase.
Original Coder Limit—what is the maximum amount of rewards an original GUI coder is allowed to earn during a given time period.
Fork Coder Reward—what is the amount of rewards a fork GUI coder is allowed to earn per qualifying user purchase.
Fork Coder Limit—what is the maximum amount of rewards a fork GUI coder is allowed to earn during a given time period.

For each class of rewards, the variables values are:

| Variable | Titanium | Platinum | Gold | Silver |
|---|---|---|---|---|
| Open Source | $1 to $5 | $2 to $3 | $2 | $2 |
| User Reward | | | | |
| Open Source | Multiple | Multiple | Multiple | Restaurant |
| User Limit | | | | Specific |
| Original | 2% | 1% | $2 | $1 |
| Coder Reward | | | | |
| Original | Multiple | Multiple | Multiple | Restaurant |
| Coder Limit | per month | per year | per year | Specific |
| Fork Coder | 1% to 5% | 1% to 3% | 1% to 2% | 1% |
| Reward | | | | |
| Fork Coder | Once | Once | Once | Restaurant |
| Limit | per week | per year | per year | Specific |

Recognition-based reward management module 206 selects the class of rewards for the user based on the key variables and the total value. For example, once the variables are selected for the user, recognition-based reward management module 206 compares the social recognition variables against the class-of-rewards variables to determine which classes-of-rewards are suitable for the user. The total value is used to select from among the suitable classes-of-rewards. For example, both the Titanium and Platinum classes-of-rewards may be suitable for a given user. The Titanium class-of-rewards may be used if the user has a total value higher than 10 and the Platinum class-of-rewards may be used if the user has a total value of 10 or lower.

For the social recognition reward, recognition-based management module 206 selects a reward zone based on the selected class of rewards. Typically, each class-of-rewards is pre-assigned to a reward zone, and a reward zone is typically pre-selected by a participating restaurant. New zones and classes-of-rewards may be implemented over time.

A rule processing module 204 retrieves account dietary rules and processes qualifying food purchases made during a dining experience at a restaurant according to the applicable account dietary rules, assigning the purchases to the appropriate accounts based on the rules. As described herein, individuals and groups (e.g., social networks, employers, etc.) may provide criteria for how purchases should be routed to different accounts in the form of account dietary rules. Account dietary rules may be generated in advance of a reservation being made, and may be saved to or otherwise associated with an account belonging to an individual or group. As qualifying food purchases are made, and as additional account dietary rules are applied during the guest dining experience at a restaurant, the rule processing module 204 evaluates the qualifying food purchases according to applicable account dietary rules, the rule processing module 204 may evaluate the account dietary rules that are applied to a dining experience at a restaurant in a priority order. For example, the rule processing module 204 may evaluate all group account dietary rules associated with a dining experience at a restaurant before any individual account dietary rules, such that any group rules for which the rule criteria are met will be applied over any individual dietary rules.

The rules processing module 204 may perform cascaded evaluations to route a qualifying food purchase. For example, an account dietary rule may specify a destination account instead of a specific account to which the purchase should be routed. The destination account may be associated with an individual, such as a guest, or a group, such as an employer.

A purchase processing module 206 applies specified redemption methods to qualifying food purchases made during a dining experience at a restaurant. Each account associated with a dining experience at a restaurant corresponds to one or more redemption methods, and each of the purchases listed in an account may be applicable to the redemption method corresponding to the account. The purchase processing module 206 may cause the interface module 202 to generate a prompt during the check-out of a guest which may, for example, collect cash to be applied to purchases listed in accounts for which cash is the corresponding redemption method.

The system 200 tracks dining-out experience and nutritional values over time. Until the reward balance is settled up, each person's outstanding balance may go up and down. On the homepage, you'll find a tally of the redeemable amount and you can settle your balance at any time—you don't have to wait until the end of the month. In one embodiment of the invention, cash redemptions may be settled directly from the system 200.

In some embodiments of the invention, the system 200 may handle a variety of dining-out scenarios: When one person orders redeemable dishes or multiple people have ordered redeemable dishes, it may split redeemable offers evenly based on the dishes or allow you to select individual dishes for each person to redeem. The share function allows you to send a dining-out experience via email, social media, or any other channel. Dining-out experiences are backed up and synced for all people in the group so each person can see them.

For example, shared items like appetizers would be split among the entire group or just a few people in the group. In some embodiments of the invention, the system 200 may accommodate large parties by allowing you to add up to 10 people to each group. Once you've divided up the food among all the plates, the final tally may be shared to each person text or email.

FIG. 3A is a flowchart illustrating an example process 300, implemented by sustainable dining experience system 200, for receiving one or more account dietary rules and associating the one or more account dietary rules with a dining experience at a restaurant or with a guest, corporate, or other account for later association with a dining experience at a restaurant. Each account dietary rule specifies a destination account to which a qualifying food purchase should be routed when criteria associated with the dietary rule are Satisfied.

At a block 305, sustainable dining experience system 200 receives either a dining experience identifier identifying a dining experience at a restaurant to which the generated account dietary rules will be applied, or the system 200 receives an account identifier associated with a guest, a group of guests, a business, an agency, or other account. If the system 200 receives an account number or other identifier corresponding to an individual or group, the received account dietary rules are stored by the system 200 in association with the received account identifier. Once stored in association with the account identifier, the dietary rules may then be applied by the system 200 to purchases associated with one or more subsequent dining experiences of the guest, group, staff of the company, etc.

At a block 310, sustainable dining experience system 200 receives an account dietary rule, which includes an indication of a destination account and a set of criteria that when satisfied will cause a qualifying food purchase to be routed to the destination account. Criteria for the account dietary rule may specify characteristics of the item being purchased as well as when the purchase was made. Different categories of criteria may be set for different account dietary rules, with different levels of specificity, which enables a user of the system 200 to generate a robust set of rules by which qualifying food purchases made during the dining experience will be evaluated.

Referring to FIG. 3B, some examples of different received account dietary rules are illustrated in table 350. The table 350 includes a rule ID field 352 identifying each listed rule and criteria such as item or service code 354, source of purchase 356, applicable date range 358, and applicable price range 360. The table 350 also includes a destination account field 362 identifying the account to which purchases satisfying the listed criteria should be routed, and a group account field 364 identifying the account to which purchases satisfying the listed criteria should be assigned. For example, the account dietary rule 366 identified by the identifier “3G3D” in the table indicates that the purchase for a guest dining at the restaurant from Feb. 2-3, 2019 should be assigned to a particular account (“Personal account”) associated with a corporate account (“ABC Corp.”) that is responsible for the purchase. As another example, the account dietary rule 368 identified by the identifier “3G2E” in the table indicates that any purchases less than or equal to $500 for dosa or crepe at a restaurant from Feb. 7-12, 2019 should be assigned to a corporate account (“ABC Corp.”), but any changes greater than $500 for dosa or crepe at a restaurant during that same date range should be routed to a personal account. Because the account dietary rule 368 does not specify a destination account for purchases routed to the corporate account, account dietary rules associated with the corporate account may be evaluated to determine the specific destination account for the purchase.

Returning to FIG. 3A, at a decision block 325, sustainable dining experience system 200 determines if there are additional account dietary rules, processing returns to the block 310. If it is determined that there are no additional account dietary rules, processing continues to block 330.

At the block 330, sustainable dining experience system 200 checks the received account dietary rules. Checks may evaluate the validity of individual account dietary rules. For example, the system 200 may evaluate whether an account dietary rule specifies a date range outside of the date range of a corresponding dining experience at a restaurant.

After the received rules are checked, processing continues to a block 335, where the checked rules are associated with either the received dining experience or account identifier. When the account identifier is a group (e.g., a corporate retreat at a resort), the checked account dietary rules may be associated with the dining experiences of all guests belonging to that group (e.g., all reservations made by the guests that are participating in the retreat).

Once account dietary rules have been received by sustainable dining experience system 200, the system 200 may apply the rules to qualifying food purchases associated with a dining experience at a restaurant. FIG. 4 is a flowchart illustrating an example process 400 for processing purchases associated with a dining experience at a restaurant.

At block 405, sustainable dining experience system 200 receives an indication of a qualifying food purchase. The indication may include the locally sourced ingredients being purchased, the category of the purchase, the amount being purchased, the source of the purchase, the date of the purchase, a description of the purchase, nutritional values, and other information that may be used to process the purchase. Further, the locally sourced ingredients are characterized by a common nutritional value that comes from the foods we eat and affects the overall performance of our brains including at least one of EPA, DHA, Choline, vitamin E, vitamin B12, calcium, zinc, and high-quality protein. The indication of the qualifying food purchase may be received directly from a point of sale system of the restaurant, or may be received after initial processing by back-end financial systems associated with the restaurant.

At block 410, sustainable dining experience system 200 retrieves account dietary rules that apply to the dining experience. As discussed previously, both individual account dietary rules and group account dietary rules may be retrieved. That is, an individual guest may have individual account dietary rules, previously generated by the guest, that are applied to the guest's dining experience at a restaurant. Additionally or alternatively, the dining experience may be associated with a group, and group account dietary rules associated with the group may also be applied to the dining Experience.

At a block 415, the received purchase is processed by sustainable dining experience system 200 according to the retrieved account dietary rules. The criteria for each of the account dietary rules are evaluated by the system 200 to determine whether they are satisfied by the received purchase. If more than one account dietary rule's criteria is satisfied, then the system 200 may select the account dietary rule that will be applied. The qualifying food purchase is then assigned to the destination account or destination account associated with the selected account dietary rule.

At the block 435, sustainable dining experience system 200 finalizes the accounts associated with the dining experience and prepares the accounts for settlement. At a block 440, the system 200 applies the analysis instruments attached to each account to settle the purchases in the account. The purchases are settled by the purchase processing module 206, which applies the redemption method or methods corresponding to the account.

At a block 405, sustainable dining experience system 200 receives an indication of a qualifying food purchase. The indication may include locally sourced ingredients being purchased, the category of the purchase, the amount being purchased, the source of the purchase, the date of the purchase, a description of the purchase, and other information that may be used to process the purchase. Further, locally sourced ingredients are characterized by a common nutritional value that comes from the foods we eat and affects the overall performance of our brains including at least one of EPA, DHA, Choline, vitamin E, vitamin B12, calcium, zinc, and high-quality protein. The indication of the qualifying food purchase may be received directly from a point of sale system of the restaurant, or may be received after initial processing by back-end financial systems associated with the restaurant.

### BRIEF DESCRIPTION OF THE DRAWING

FIG. 1 is a diagram of an example environment in which a system for rules-based analysis of qualifying food purchase may operate.

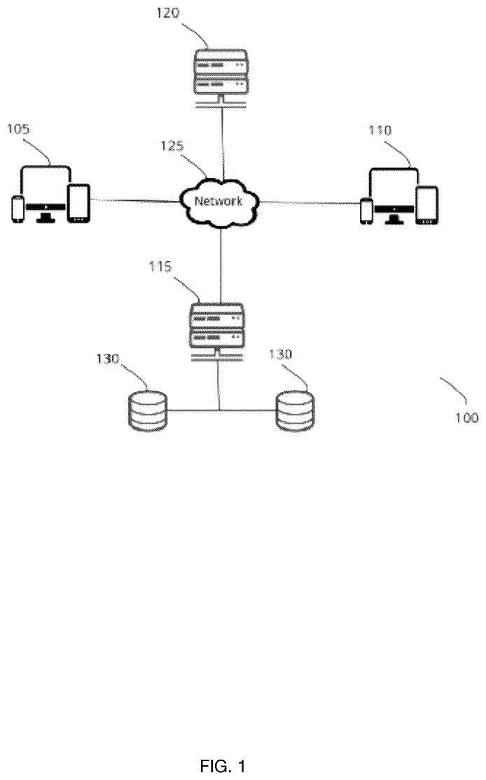

FIG. 2 is a block diagram of the rules-based sustainable dining experience system.

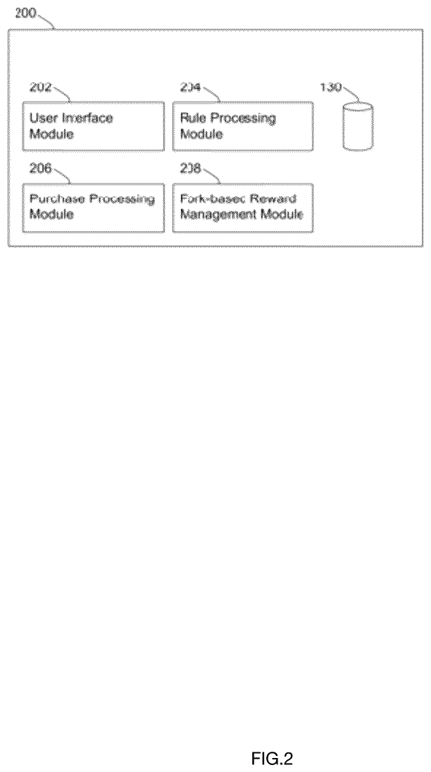

FIG. 3A is a flow diagram of a process for generating account dietary rules associated with a dining experience at a restaurant.

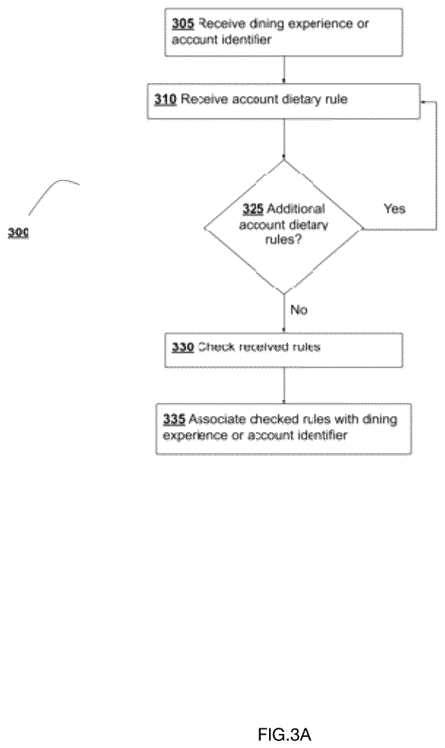

FIG. 3B is a table of example dietary rules.

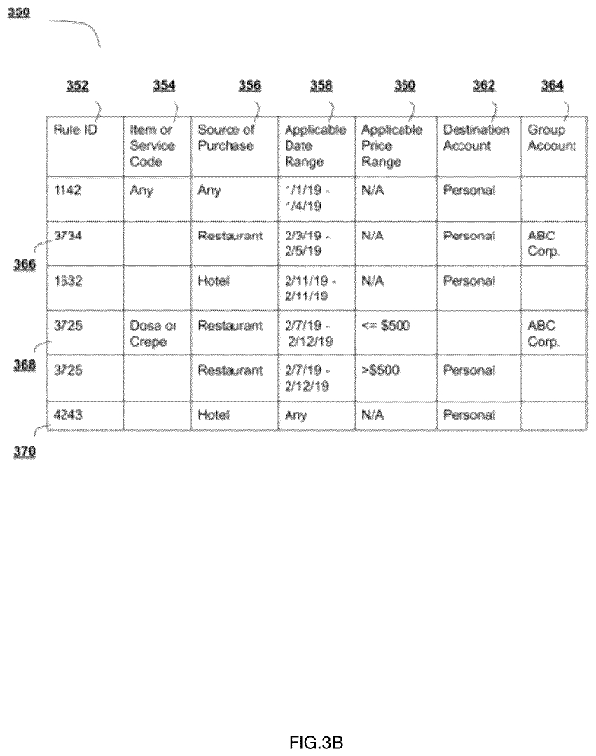

FIG. 4 is a flow diagram of a process for assigning qualifying food purchases during a dining experience at a restaurant to different accounts based on associated rules.

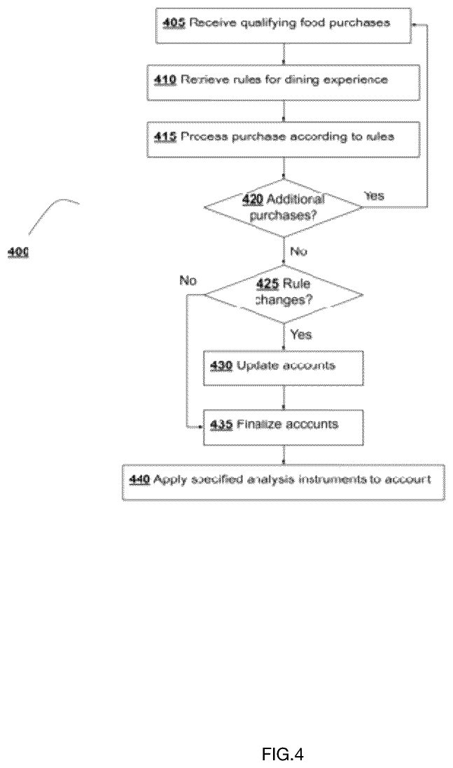

FIG. 5 is a flow diagram for providing vegan dishes driven by consumer behavior analysis.

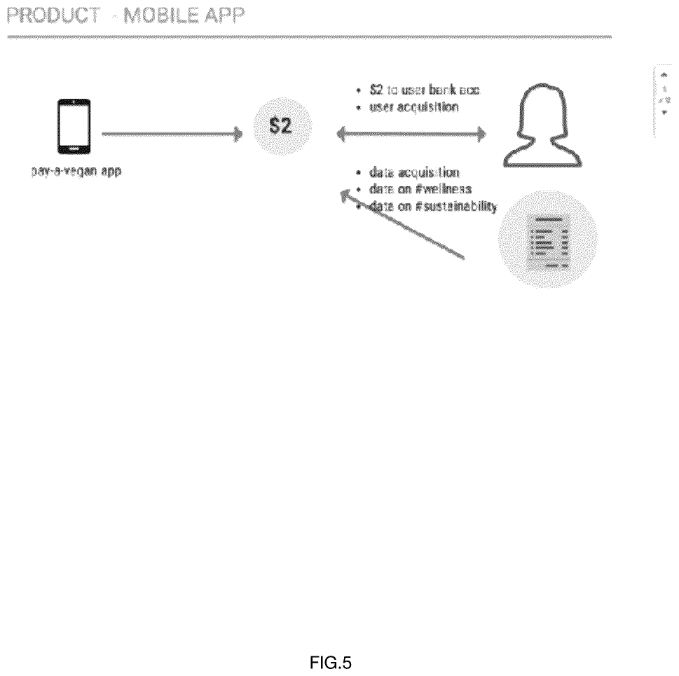

FIG. 6 is a block diagram for promoting vegan eating habits by means of monetary return.

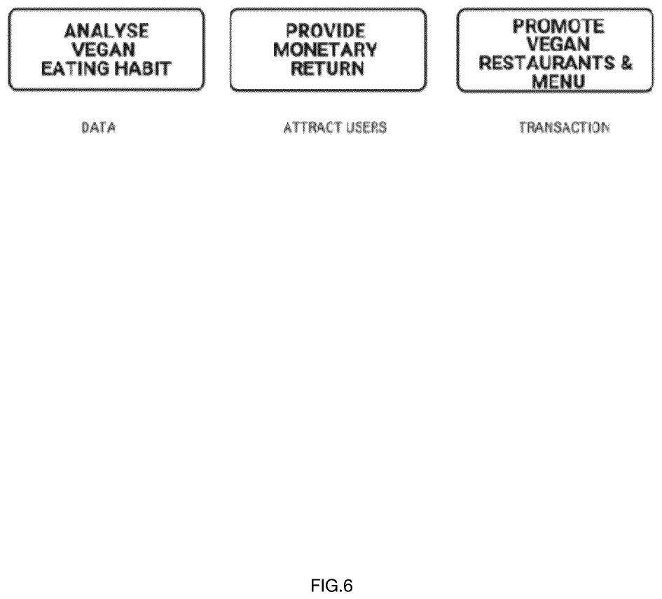

FIG. 7 is a flow diagram for uploading a receipt to get paid.

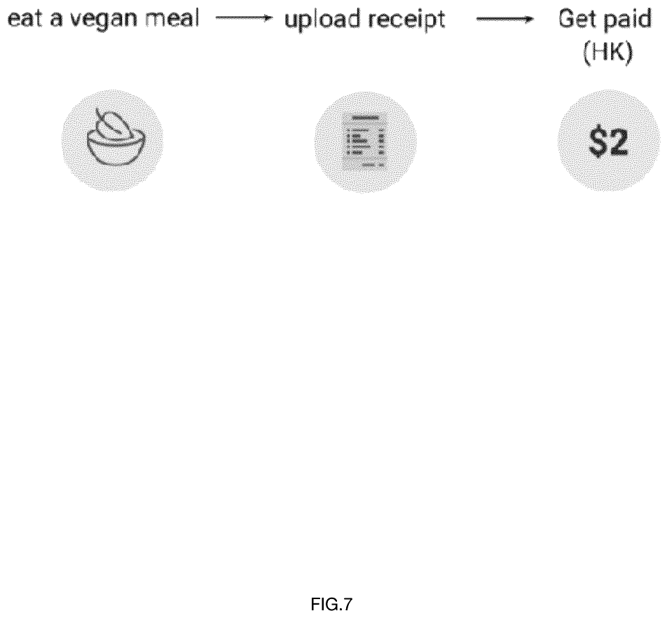

1: An automatic cash redemption method, wherein a picture of a receipt is uploaded using an open source GUI to receive reward offered for select locally sourced ingredients included in qualifying food purchases characterized by common nutritional values on a list of dietary recommendations, the method comprising:
retrieving, using at least one processor and memory included in a sustainable dining experience system, one or more dietary rules associated with the dining experience at the restaurant, wherein at least one of the dietary rules is associated with an individual guest and wherein at least one of the dietary rules is associated with a group of guests; and
determining a plurality of total values based on social recognition factors associated with a destination account, wherein the social recognition factors include at least one of advocacy, role modeling, and forking.

2: The method of claim 1, further comprising presenting on a display a qualifying food purchase or presenting through an application programming interface a qualifying food purchase.

3: The method of claim 2, further comprising limiting the presentation of certain qualifying food purchases depending on a type of user of the sustainable dining experience system.

4: The method of claim 1, further comprising:
receiving, at a recognition-based reward management module, a plurality of qualifying food purchases made during a dining experience at a restaurant, wherein each qualifying food purchase comprises a plurality of locally sourced ingredients and one or more nutritional values of the qualifying food purchase, the plurality of locally sourced ingredients characterized by a common nutritional value on the list of dietary recommendations including at least one of EPA, DHA, Choline, vitamin E, vitamin B12, calcium, zinc, and high-quality protein;
executing, at the recognition-based reward management module, a first operation to obtain initial results, wherein the initial results comprise a plurality of user entries that match a selection criteria and a plurality of classes-of-rewards associated with the plurality of user entries that match the selection criteria, wherein the selection criteria includes the destination account and a successor-predecessor relationship of the open source GUI, the successor-predecessor relationship comprising a predecessor coder, and a successor coder;
determining, at the recognition-based reward management module, rewards offered to the plurality of user entries;
assigning each of the received food purchases to destination accounts associated with the dining experience at the restaurant by:
evaluating whether the qualifying food purchase satisfies a dietary rule based on the plurality of locally sourced ingredients, nutritional values of the qualifying food purchase, and criteria associated with the dietary rule; and
assigning the qualifying food purchase to a destination account associated with the dietary rule based on the evaluation; and
processing each of the received qualifying food purchases based on a method of redemption associated with the destination account to which the qualifying food purchase was assigned.

5: A sustainable dining experience system for automatic cash redemption, wherein a picture of a receipt is uploaded using an open source GUI to receive reward offered for select locally sourced ingredients included in qualifying food purchases characterized by common nutritional values on a list of dietary recommendations, the system comprising:
a rule processing module configured to:
receive a plurality of qualifying food purchases made during a dining experience at a restaurant, wherein each qualifying food purchase comprises a plurality of locally sourced ingredients and one or more nutritional values of the qualifying food purchase, the plurality of locally sourced ingredients characterized by a common nutritional value on the list of dietary recommendations including at least one of EPA, DHA, Choline, vitamin E, vitamin B12, calcium, zinc, and high-quality protein;
retrieve, using at least one processor and memory included in a sustainable dining experience system, one or more dietary rules associated with the dining experience at the restaurant, wherein each dietary rule comprises a destination account and one or more criteria; and
a recognition-based reward management module configured to:
execute a first operation to obtain initial results, wherein the initial results comprise a plurality of user entries that match a selection criteria and a plurality of classes-of-rewards associated with the plurality of user entries that match the selection criteria, wherein the selection criteria includes the dietary rule destination account and a successor-predecessor relationship of the open source GUI, the successor-predecessor relationship comprising a predecessor coder, and a successor coder; and
determine a plurality of total values based on social recognition factors associated with a destination account.

6: The system of claim 5, further comprising:
an interface module configured to:
present, on a display, an assigned qualifying food purchase, or
provide, through an application programming interface, the destination account to which a qualifying food purchase was assigned.

7: The system of claim 6, wherein the interface module is further configured to limit the display of certain assigned qualifying food purchases depending on a type of user of the sustainable dining experience system.

8: The system of claim 5, wherein the rule processing module is further configured to associate the at least one of the dietary rules with an individual guest, and at least one of the dietary rules with a group of guests; and
assign each of the received qualifying food purchases to destination accounts associated with the dining experience at the restaurant by:
evaluating whether the qualifying food purchase satisfies a dietary rule based on the plurality of locally sourced ingredients, nutritional values of the qualifying food purchase, and the dietary rule criteria; and
assigning the qualifying food purchase to the dietary rule destination account based on the evaluation.

9: A non-transitory computer-readable medium encoded with instructions that, when executed by a processor, perform an automatic cash redemption method for processing qualifying food purchases at affiliate restaurants, wherein a picture of a receipt is uploaded using an open source GUI to receive reward offered for select locally sourced ingredients included in qualifying food purchases characterized by common nutritional values on a list of dietary recommendations, the method comprising:
receiving, using at least one processor and memory included in a sustainable dining experience system, a plurality of qualifying food purchases made during a dining experience at a restaurant, wherein each qualifying food purchase comprises a plurality of locally sourced ingredients and one or more nutritional values of the qualifying food purchase, the plurality of locally sourced ingredients characterized by a common nutritional value on the list of dietary recommendations including at least one of EPA, DHA, Choline, vitamin E, vitamin B12, calcium, zinc, and high-quality protein;
retrieving, using at least one processor and memory included in the sustainable dining experience system, one or more dietary rules associated with the dining experience at the restaurant, wherein each dietary rule comprises a destination account and one or more criteria;
executing, using at least one processor and memory included in the sustainable dining experience system, a first operation to obtain initial results, wherein the initial results comprise a plurality of user entries that match a selection criteria and a plurality of classes-of-rewards associated with the plurality of user entries that match the selection criteria, wherein the selection criteria includes the destination account and a successor-predecessor relationship of the open source GUI, the successor-predecessor relationship comprising a predecessor coder, and a successor coder;
assigning a higher social recognition value determined by fork frequency within a predefined period of time;
querying a plurality of classes-of-rewards stored in a data repository to obtain an interested class-of-rewards list, wherein each class-of-rewards included in the interested class-of-rewards list comprises an InterestedRestaurant attribute specifying that the class-of-rewards is associated with the restaurant, and
determining a plurality of total values based on social recognition factors associated with the destination account;
comparing the plurality of total values against the one or more classes-of-rewards key variables to assign classes-of-rewards to the plurality of user entries; and
determining, using at least one processor and memory included in the sustainable dining experience system, rewards offered to the plurality of user entries.

10: The non-transitory computer-readable medium of claim 9, wherein the at least one of the dietary rules is associated with an individual guest and wherein at least one of the dietary rules is associated with a group of guests.

11: The non-transitory computer-readable medium of claim 9, wherein the automatic cash redemption method further comprises:
assigning each of the received food purchases to destination accounts associated with the dining experience at the restaurant by:
evaluating whether the qualifying food purchase satisfies a dietary rule based on the plurality of locally sourced ingredients, nutritional values of the qualifying food purchase, and the dietary rule criteria; and
assigning the qualifying food purchase to the dietary rule destination account based on the evaluation.
